(19) United States
(12) Patent Application Publication
(10) Pub. No.: US 2023/0202385 A1
(43) Pub. Date: Jun. 29, 2023

(54) Vehicular Front Brake Light System

(71) Applicants: Allen Snipe, Newark, DE (US); Maria Snipe, Newark, DE (US)

(72) Inventors: Allen Snipe, Newark, DE (US); Maria Snipe, Newark, DE (US)

(21) Appl. No.: 18/069,246

(22) Filed: Dec. 21, 2022

Related U.S. Application Data
(60) Provisional application No. 63/293,158, filed on Dec. 23, 2021.

(51) Int. Cl. B60Q 1/44; B60Q 1/00

(52) U.S. Cl. CPC B60Q 1/442; B60Q 1/0023; B60Q 2400/20

(57) ABSTRACT

The present invention relates to a front brake light system and a vehicle equipped with the front brake light system. The front brake light system includes a plurality of LEDs and an impact camera. The LEDs are illuminated in a color such as red when the brake pedal of vehicle is depressed by the driver, thereby alerting users in front of the vehicle of the braking process. The impact camera starts to record images and/or videos of an area in front of the vehicle when the brake pedal of the vehicle is depressed by the driver. The front brake light system receives electrical power from the internal electrical power of the vehicle and is actuated when the brake pedal is depressed. The front brake light system can be hexagonal in shape. In some embodiments, the front brake light system works simultaneously with a conventional rear brake light system.

### CROSS-REFERENCE TO RELATED APPLICATION

The present application claims priority to, and the benefit of, U.S. Provisional Application No. 63/293,158, which was filed on Dec. 23, 2021 and is incorporated herein by reference in its entirety.

### FIELD OF THE INVENTION

The present invention relates generally to the field of brake lights. More specifically, the present invention relates to a novel front brake light for vehicles. The front brake light has a red hexagonal body having “STOP” printed thereon. The light system includes a plurality of LEDs and an impact camera, the LEDs are illuminated using vehicular electric power and the impact camera also receives power for internal electric supply of the vehicle. When a brake pedal of the vehicle is depressed, electric power is supplied and the light system is actuated to alert other drivers and pedestrians in front of the vehicle about the braking process. Accordingly, this present disclosure makes specific reference thereto. Nonetheless, it is to be appreciated that aspects of the present invention are also equally applicable to other like applications, devices, and methods of manufacture.

### BACKGROUND

By way of background, brake lights are disposed at the back of vehicles and are configured to automatically turn on when brakes are applied. When a driver presses the brake pedal, brake lights are illuminated to alert other drivers, motorists, and pedestrians about braking to increase everyone's safety on the road. Brake lights are usually brighter than the regular taillights allowing other individuals to view the lights, from a long distance. In fact, it is regulatory requirement to have brake lights and helps in avoiding collisions and serious accidents. Conventionally, red illuminating LEDs or halogens are used in brake lights to alert other drivers, motorists, and pedestrians positioned to the rear of the vehicle.

As conventional brake lights are positioned at the back of the vehicle, therefore, pedestrians, other vehicle drivers, and more positioned in front of a vehicle cannot be alerted of deceleration of the vehicle when brakes are applied. This may cause collisions and serious accidents as pedestrians and the other drivers may not know when the vehicle is slowing down. Therefore, individuals desire a device and system that alerts individuals in front of a vehicle on application of brakes of the vehicle.

It is surprising that safety lights are deployed inside the vehicle, rear of the vehicle and sides of the vehicle, but any kind of warning signals for braking of the vehicle are not deployed in front of the vehicle. Common headlamps are used only for illuminating area in front of the vehicle but does not provide any kind of signal about braking of the vehicle. Drivers and pedestrians require an illumination system that can be deployed in front of the vehicle to alert others in front of the vehicle that the vehicle is in the process of braking.

Rear cameras are also deployed in vehicles allowing drivers to view areas to the rear of the vehicle but no cameras or surveillance means are provided in front of the vehicle. Drivers desire cameras to record and capture views in front of the vehicle especially when brakes are applied allowing drivers to see what is present in front of the vehicle.

Therefore, there exists a long-felt need in the art for a brake light system that can be affixed to the front of a vehicle. There is also a long-felt need in the art for a front brake light system that alerts others in front of the vehicle about braking of the vehicle. Additionally, there is a long-felt need in the art for a brake light system that can be integrally attached to a front of a vehicle during manufacturing of the vehicle. Moreover, there is a long-felt need in the art for a front brake light system that works simultaneously with the rear brake lights to alert others about braking of the vehicle. Further, there is a long-felt need in the art for a brake light system that improves roadway safety and ensures all other vehicles and pedestrians are aware of braking regardless of being at the front or the rear of the vehicle. Furthermore, there is a long-felt need in the art for a brake light system that includes an impact area for capturing images and videos in front of the vehicle. Finally, there is a long-felt need in the art for a front brake light system that improves safety, and prevents collisions and serious injuries.

The subject matter disclosed and claimed herein, in one embodiment thereof, comprises a front brake light system for vehicles. The front brake light system is mounted in front of a vehicle, preferably where the front license or vanity plate is located to alert other drivers and pedestrians in front of the vehicle about braking of the vehicle. The front brake light is in the shape of a red and white hexagon. The light includes a plurality of LED strips, each strip including a matrix of LEDs for illumination upon pressing of brake pedal of the vehicle to indicate braking process of the vehicle and alert other users of deceleration of the vehicle. The front brake light also has an impact camera for recording images and/or videos in front of the vehicle, wherein the impact camera is turned on when a brake pedal of the vehicle is depressed. When the brake pedal is depressed, the front brake light receives electric power from the internal electric supply of the vehicle for operation of the LEDs and impact camera.

In this manner, the front brake light system of the present invention accomplishes all of the forgoing objectives and provides vehicles with a front brake light capable of illuminating when brake pedal is depressed. The system improves roadway safety and ensures all other vehicles and pedestrians are aware of vehicles braking when viewing them from an area in front of the vehicle. The system works simultaneously with the rear brake lights for providing overall security and coverage. The light system improves safety and ensures all other vehicles and pedestrians are aware the vehicle is braking from different points of view.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a front brake light system. The front brake light system is mounted in front of a vehicle to alert other drivers and pedestrians in front of the vehicle about the braking of the vehicle for improving roadway safety and preventing collisions. The front brake light is in the shape of a red and white hexagon having a textual “STOP” disposed thereon. The light includes a plurality of LED strips including at least a pair of vertical LED strips and a pair of horizontal LED strips, each strip including a longitudinal matrix of LEDs for illumination upon pressing of brake pedal of the vehicle to indicate braking process of the vehicle, and to alert other observers of deceleration of the vehicle. The front brake light also has an impact camera for recording images and/or videos in front of the vehicle wherein the impact camera is turned on when brake pedal of the vehicle is depressed. The front brake light receives electric power from the internal electric supply of the vehicle thereby eliminating requirement of external electrical supply.

In yet another embodiment, a front brake light system is disclosed. The front brake light system is disposed in front of the vehicle and features two hexagonal shaped bodies having stop text printed thereon. A plurality of LED strips, each strip comprising matrix of LEDs are integrated for illumination in red color, a circuit for coupling the LEDs to the internal electrical supply of the vehicle such that the LEDs are energized and illuminated when a brake pedal of the vehicle is depressed and electrical power is received via the circuit. The front brake light system has a dimension of generally 8 inches by 5 inches, and includes an impact camera for recording images and/or videos of front of the vehicle wherein the impact camera is turned on when brake pedal of the vehicle is depressed.

In yet another embodiment, a vehicle equipped with front brake light system and rear brake light system is disclosed. The vehicle comprising a brake pedal for allowing the vehicle to decelerate in response to depression of the brake pedal; a front brake light system disposed in front of the vehicle where the front license or vanity plate is located; the front brake light system has a plurality of LEDs and an impact camera; a circuit coupled to internal electrical wiring of the vehicle for receiving vehicular electrical supply; the LEDs are energized and illuminated when the brake light is depressed enabling the LEDs and the impact camera to receive vehicular electrical supply via the circuit.

In an additional embodiment of the presently described invention, a method for alerting drivers and pedestrians positioned in front of a vehicle is described. The method includes the steps of installing a brake light system in front of the vehicle, the brake light system includes a plurality of LEDs and an impact camera, coupling the light system to the internal electrical circuit of the vehicle, pressing a brake pedal of the vehicle, supplying vehicular electrical power to the LEDs of the brake light system for illumination to alert other drivers and pedestrians, and activating the impact camera to record images and videos, storing the images and video on a remote server.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a vehicle equipped with one potential embodiment of front brake light system of the present invention in accordance with the disclosed architecture;

FIG. 2 illustrates a perspective view showing another embodiment of the front brake light system of the present invention in accordance with the disclosed architecture;

FIG. 3 illustrates a perspective view of a vehicle equipped with the dual front brake light system and a pedestrian being alerted using the light system in accordance with the disclosed architecture; and

FIG. 4 illustrates a functional block diagram showing high level schematic view of the front brake light system of various embodiments of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a brake light system that can be affixed to the front of a vehicle. There is also a long-felt need in the art for a front brake light system that alerts others in front of the vehicle about the braking of the vehicle. Additionally, there is a long-felt need in the art for a brake light system that can be integrally attached to a front of a vehicle during manufacturing of the vehicle. Moreover, there is a long-felt need in the art for a front brake light system that works simultaneously with the rear brake lights to alert others about braking of the vehicle. Further, there is a long-felt need in the art for a brake light system that improves roadway safety and ensures all other vehicles and pedestrians are aware of braking regardless of being at the front or the rear of the vehicle. Furthermore, there is a long-felt need in the art for a brake light system that includes an impact area for capturing images and videos in front of the vehicle. Finally, there is a long-felt need in the art for a front brake light system that improves safety, and prevents collisions and serious injuries.

The present invention, in one exemplary embodiment, is a vehicle equipped with a front brake light system and a rear brake light system. The vehicle comprising a brake pedal for allowing the vehicle to decelerate in response to depression of the brake pedal; a front brake light system disposed in front of the vehicle where the front license or vanity plate is located; the front brake light system has a plurality of LEDs and an impact camera; a circuit coupled to internal electrical wiring of the vehicle for receiving vehicular electrical supply; the LEDs are energized and illuminated when the brake light is depressed enabling the LEDs and the impact camera to receive vehicular electrical supply via the circuit. The front brake light system and rear brake light system simultaneously work together ensuring all other vehicles and pedestrians are aware of a vehicle's braking regardless of viewing the vehicle from the front or the back.

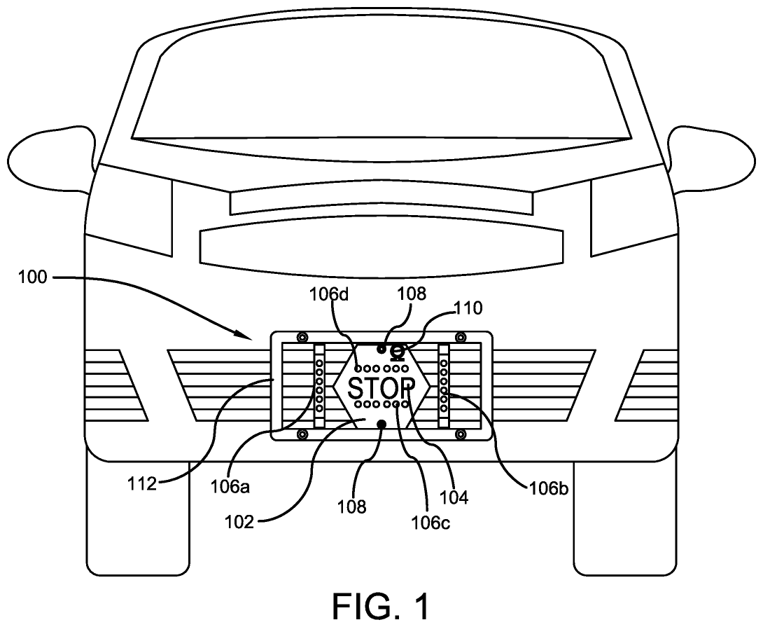

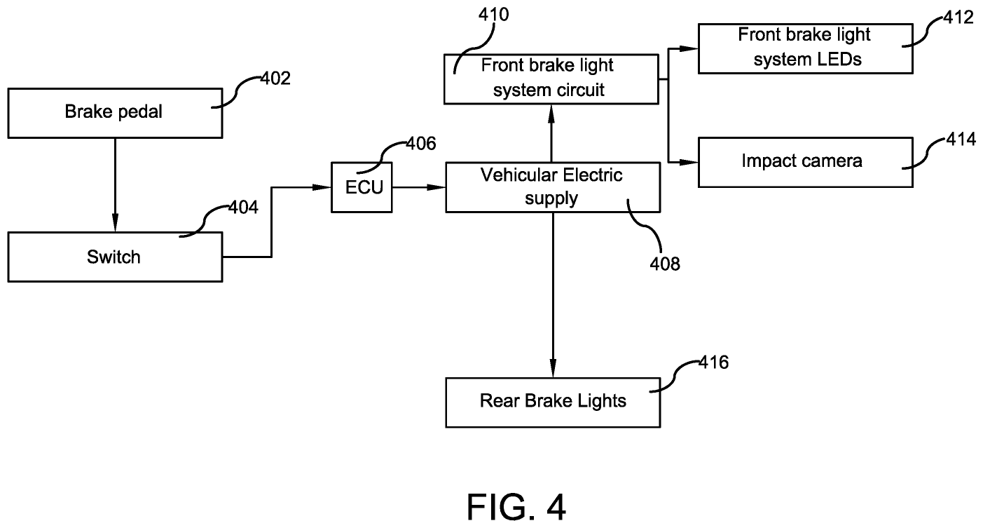

Referring initially to the drawings, FIG. 1 illustrates a perspective view of a vehicle equipped with one potential embodiment of a front brake light system of the present invention in accordance with the disclosed architecture. The front brake light system 100 of the present embodiment is designed as a hexagonal single brake light 102 having a “STOP” text 104 printed thereon. The light system 100 is designed to mount on the front of the vehicle and preferably where the front license or vanity plate is located. The light system 100 is connected to internal electrical supply of the vehicle for providing electrical power to LEDs embedded in the light system 100 as described in FIG. 4. The light system 100 has a plurality of LEDs 106a-d that are illuminated when a brake pedal is depressed by a driver of the vehicle. Each LED is in the form of a strip and is about 8-inches in length. The LEDs may illuminate in a flashing or continuous manner and includes bright red color for maximizing visibility even in lowlight areas and in night.

The light system 100 preferably measures generally 8 inches by 5 inches such that the system 100 can be easily and securely mounted onto the vehicle. The light system 100 is mounted using a fastening means 108, such as, mechanical screws (bolts, nuts, and washers), or alternatively can be mounted using waterproof adhesive and the like. The hexagonal brake light 102 can have an impact camera 110 for capturing images and/or video when the brake pedal is depressed by the driver. The LEDs 106a-d and the camera 110 are automatically activated upon pressing the brake pedal for signaling to everyone in front of the vehicle.

It should be appreciated that the front brake light system 100 can work in conjunction with (i.e., synch with) conventional brake lights positioned at the back of the vehicle for providing overall protection to other drivers, pedestrians, and motorists. The light system 100 has supplemental wiring to connect with the internal electrical wiring of the vehicle for electrical connection. The light system 100 is protected by a substantially transparent covering 112 for protection from physical damage. The two LEDs of the four LEDs 106a-d can be oriented vertically and the remaining two LEDs 106c-d can be oriented horizontally, thereby providing adequate illumination in front of the vehicle for oncoming traffic.

The impact camera 110 can be an IP camera and may have a resolution between 1 MP to about 3 MP. The camera 110 can have a range from about 5 meters to about 20 meters. The recordings from the impact camera 110 can be stored in a cloud storage on a remote server for secure access by a user. The impact camera 110 is integrated with the dashboard of the vehicle and live recording can be visible on the dashboard.

In some embodiments of the present invention, the LEDs can also be disposed along the text “STOP” so that STOP is also illuminated. There is no limit to the orientation in which the LEDs are integrated in the light system 100. The LEDs are energized upon receiving electrical power when the brake pedal is depressed and all the individual LEDs are simultaneously energized for providing adequate illumination.

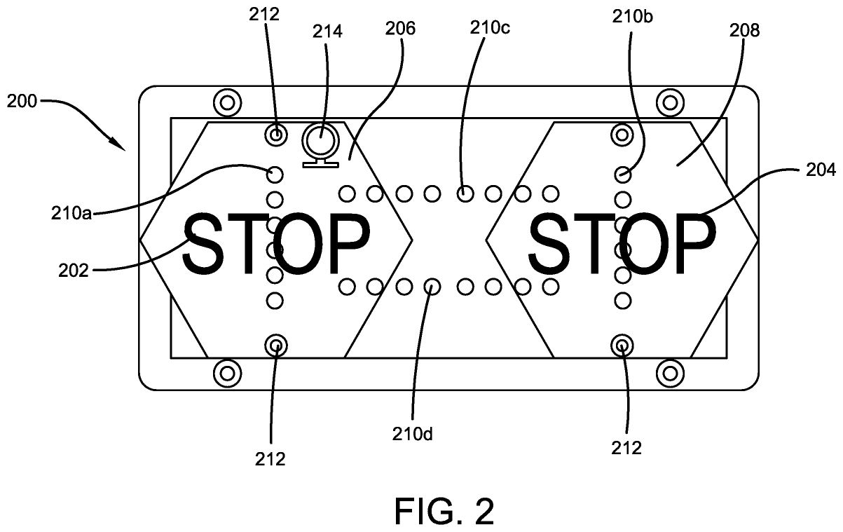

FIG. 2 illustrates a perspective view showing another embodiment of the front brake light system of the present invention in accordance with the disclosed architecture. In the present embodiment, the front brake light system 200 includes a pair of illuminating stop signs 202, 204 wherein each stop sign is disposed independently on red and white hexagonal bodies 206, 208. The dual front brake light system 200 is designed for bigger vehicles, SUVs, trucks, and more that have a bigger front portion. The light system 200 has a pair of vertical LEDs 210a, 210b embedded separately in hexagonal signs 206, 208 and a pair of horizontal LEDs 210c, 210d are positioned across the hexagonal bodies 206, 208.

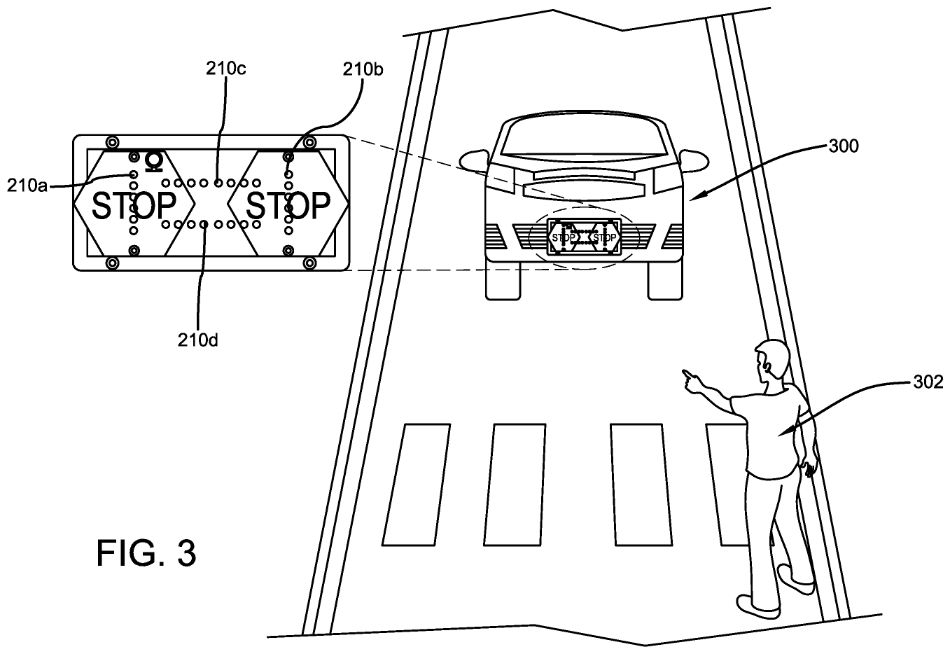

The LEDs 210a-d are illuminated simultaneously using electrical power provided by the vehicle, thereby obviating any additional power supply. The LEDs 210a-d are energized when the brake pedal is depressed and the electrical supply of the vehicle is connected to the LEDs. The dual brake light system 200 is removably attached to the front of a vehicle as illustrated in FIG. 3 using mechanical fasteners 212 that are fastened using nuts, bolts, and washers.

The light system 200 can include an impact camera 214 for recording and capturing images/video in front of the vehicle and is configured to automatically record when brake pedal is depressed by a driver.

FIG. 3 illustrates a perspective view of a vehicle equipped with the dual front brake light system 200 and a pedestrian being alerted using the light system in accordance with the disclosed architecture. As illustrated, the vehicle 300 has the light system 200 fastened in the front portion such that the illuminated LEDs are easily visible to individuals such as a pedestrian 302 in front of the vehicle 300. The illuminated LEDs 210a-d provide an indication that the vehicle 300 is decelerating and the brakes are applied. The front brake system 200 works in conjunction with the rear brake lights thereby allowing the individuals at the back to be aware of the braking process of the vehicle 300.

The lighting system 200 allows the pedestrian 302 to easily cross the crosswalk upon indication of the decelerating vehicle 300. Further, when the LEDs are not illuminated, the pedestrian 302 may avoid crossing the crosswalk to prevent any collision and serious injuries.

FIG. 4 illustrates a functional block diagram showing high level schematic view of the front brake light system of various embodiments of the present invention in accordance with the disclosed architecture. The light system of the present invention requires a single input of depressing the brake pedal 402 such that when the brake pedal 402 is depressed, the brake pedal switch 404 is closed for sending an instruction signal to electronic control unit (ECU) 406. Accordingly, upon receiving the instruction signal, the ECU 406 allows the vehicular electrical supply 408 to connect to the front brake light system circuit 410. It should be noted that the front brake light system circuit 410 is electrically coupled to the vehicular electrical supply 408 allowing transfer of vehicular electrical power to the front brake light system 100, 200.

Using the front brake light system circuit 410, LEDs 412 (collectively for 106a-d, 210a-d) of the light system receive the electric power and are energized and illuminated to indicate the braking process of the vehicle. Simultaneously, impact camera 414 (collectively for 110, 214) is actuated to capture images/video from the front of the vehicle in which the front brake light system is installed.

As communicated earlier, the front brake light system of various embodiments of the present invention work in conjunction with (i.e., synch with) the conventional rear brake lights 416 for providing overall protection from the vehicle. The vehicular electric supply 408 simultaneously provides electric power to the rear brake lights 416 while being coupled to the front brake light system circuit 410. It should be noted that there can be a switch placed between 408, 410 to selectively couple the circuits 408, 410.

The front brake light system can be integrated with a vehicle during manufacturing or can be retrofitted for aftermarket purposes. LEDs are preferred as the illuminating source because LEDs are highly efficient, draw less energy, have long service lives, are durable, and can be combined in many shapes and sizes. The light system comes in different colors to compliment different vehicles and for functioning as an aesthetically pleasing enclosure.

In the preferred embodiment, the preferable color for the front brake lights is red as this provides a distinct and sharp caution to denote a braking action and is also in-line with most applicable legal requirements. However, the lights could be of yellow, amber, or some other color based on regulatory approvals. The front brake light system can take a wide variety of forms and dimensions because the front portion of vehicles can have different forms and shapes, from the angles they take with respect to ground level.

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “front brake light system”, “light system”, “dual front brake light system”, and “brake light system” are interchangeable and refer to the front brake light system 100, 200 of the present invention.

Notwithstanding the forgoing, the front brake light system 100, 200 of the present invention can be of any suitable size and configuration as is known in the art without affecting the overall concept of the invention, provided that it accomplishes the above-stated objectives. One of ordinary skill in the art will appreciate that the front brake light system 100, 200 as shown in the FIGS. are for illustrative purposes only, and that many other sizes and shapes of the front brake light system 100, 200 are well within the scope of the present disclosure. Although the dimensions of the front brake light system 100, 200 are important design parameters for user convenience, the front brake light system 100, 200 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle front brake light system comprising:
a front brake light having a plurality of LEDs mounted to a front of a vehicle;
wherein said front brake light connected to an internal electrical supply of said vehicle; and
further wherein said plurality of LEDs illuminate when a brake pedal of said vehicle is depressed by a driver of said vehicle.

2. The vehicle front brake light system of claim 1, wherein said front brake light having a hexagonal shape.

3. The vehicle front brake light system of claim 1, wherein said front brake light having a “STOP” text printed thereon.

4. The vehicle front brake light system of claim 1, wherein said front brake light is centered around a front license plate area.

5. The vehicle front brake light system of claim 1, wherein said plurality of LEDs in a form of a strip generally about 8 inches in length.

6. The vehicle front brake light system of claim 1, wherein said plurality of LEDs are flashing LEDs.

7. The vehicle front brake light system of claim 1, wherein said plurality of LEDs are red in color.

8. The vehicle front brake light system of claim 1 further comprising an impact camera for capturing images when the brake pedal of said vehicle is depressed by a driver of said vehicle.

9. The vehicle front brake light system of claim 8, wherein said impact camera automatically actuated upon depressing the brake pedal of said vehicle by a driver of said vehicle.

10. The vehicle front brake light system of claim 9, wherein said impact camera is a video camera.

11. The vehicle front brake light system of claim 1, wherein said front brake light synched with a vehicle's rear lights for simultaneous illumination upon depressing the brake pedal of said vehicle by a driver of said vehicle.

12. The vehicle front brake light system of claim 1, wherein said front brake light having a transparent covering for protecting said front brake light from impact.

13. The vehicle front brake light system of claim 1, wherein said plurality of LEDs having a pair of horizontal LED strips and a pair of vertical LED strips.

14. A vehicle front brake light system comprising:
a front brake light having a plurality of LEDs mounted to a front of a vehicle;
wherein said front brake light connected to an internal electrical supply of said vehicle;
wherein said plurality of LEDs illuminate when the brake pedal of said vehicle is depressed by a driver of said vehicle;
wherein said plurality of LEDs are red in color; and
further wherein said front brake light synched with a vehicle's rear lights for simultaneous illumination upon depressing the brake pedal of said vehicle by a driver of said vehicle.

15. The vehicle front brake light system of claim 14, wherein said front brake light is centered around a front license plate area.

16. The vehicle front brake light system of claim 14, wherein said plurality of LEDs are flashing LEDs.

17. The vehicle front brake light system of claim 14 further comprising an impact camera for capturing images when the brake pedal of said vehicle is depressed by a driver of said vehicle.

18. The vehicle front brake light system of claim 17, wherein said impact camera automatically actuated upon depressing the brake pedal of said vehicle by a driver of said vehicle.

19. The vehicle front brake light system of claim 18, wherein said impact camera is a video camera.

20. A vehicle front brake light system comprising:
a front brake light having a plurality of LEDs mounted to a front of a vehicle;
wherein said front brake light connected to an internal electrical supply of said vehicle;
wherein said plurality of LEDs illuminate when the brake pedal of said vehicle is depressed by a driver of said vehicle;
wherein said plurality of LEDs are red in color;
wherein said front brake light synched with a vehicle's rear lights for simultaneous illumination upon depressing the brake pedal of said vehicle by a driver of said vehicle;
an impact camera for capturing images when the brake pedal of said vehicle is depressed by a driver of said vehicle; and
further wherein said impact camera synched with said front brake light for simultaneous actuation upon depressing the brake pedal of said vehicle by a driver of said vehicle.
